(19) United States
(12) Patent Application Publication
(10) Pub. No.: US 2008/0298610 A1
(43) Pub. Date: Dec. 4, 2008

(54) Parameter Space Re-Panning for Spatial Audio

(75) Inventors: Jussi Virolainen, Espoo (FI); Jarmo Hiipakka, Espoo (FI); Pasi S. Ojala, Kirkkonummi (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/755,401

(22) Filed: May 30, 2007

(51) Int. Cl. H04S 1/00

(52) U.S. Cl. 381/307; 381/300

(57) ABSTRACT

Aspects of the invention provide methods, computer-readable media, and apparatuses for re-panning multiple audio signals by applying spatial cue coding. Sound sources in each of the signals may be re-panned before the signals are mixed to a combined signal. Processing may be applied in a conference bridge that receives two omni-directionally recorded audio signals. The conference bridge subsequently re-pans one of the signals to the listeners left side and the signal to the right side. The source image mapping and panning may further be adaptively based on the content and use case. Mapping may be done by manipulating the directional parameters prior to directional decoding or before directional mixing. Directional information that is associated with an audio input signal is remapped order to compress input source positions into virtual source positions. The virtual sources may be placed with respect to actual loudspeakers using binaural cue panning.

### FIELD OF THE INVENTION

The present invention relates to mixing spatialized audio signals. Acoustic sources may be re-panned before being mixed.

### BACKGROUND OF THE INVENTION

With continued globalization, teleconferencing is becoming increasing important for effective communications over multiple geographical locations. A conference call may include participants located in different company buildings of an industrial campus, different cities in the United States, or different countries throughout the world. Consequently, it is important that spatialized audio signals are combined to facilitate communications among the participants of the teleconference.

Some prior art spatial audio re-panning solutions perform a short time Fourier transform (STFT) analysis on the stereo signal. Within the time-frequency domain, the coherence between left and right channels is determined using cross correlation function. The coherence value indicates the dominance of ambience in stereo signal. Correlation of stereo channels also provides a similarity value indicating the stereo panning of the source within the stereo image.

However, mixing of spatialized signals may be difficult or even impractical in certain teleconferencing scenarios. For example, when two independently spatialized signals are blindly mixed, the resulting mixed signal may map sound sources to overlapping auditory locations. Consequently, the resulting mixed signal may be confusing to the participants when tracking dialog among the participants.

Consequently, there is a real market need to provide effective teleconferencing capability of spatialized audio signals that can be practically implemented by a teleconferencing system.

### BRIEF SUMMARY OF THE INVENTION

An aspect of the present invention provides methods, computer-readable media, and apparatuses for re-panning multiple audio signals by applying spatial cue processing. Sound sources may be re-panned before they are mixed to a combined signal. Processing, according to an aspect of the invention, may be applied for example in a conference bridge that receives two omni-directionally recorded audio signals. The conference bridge subsequently re-pans the given signals to the listeners left and right side. The source image mapping and panning may further be adaptively based on the content and use case. Mapping may be done by manipulating the directional parameters prior to directional decoding or before directional mixing.

With another aspect of the invention, re-panned input signals are mixed to form an output signal that is rendered to a user. The rendered output signal may be converted into an acoustic signal through a set of loudspeakers or may be recorded on a storage device.

With another aspect of the invention, directional information that is associated with an audio input signal is remapped in order to place input sources into virtual source positions. The virtual sources may be placed with respect to actual loudspeakers using spatial cue processing.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows an architecture for re-panning an audio signal according to an embodiment of the invention.

FIG. 2 shows an architecture for directional audio coding (DirAC) analysis according to an embodiment of the invention.

FIG. 3 shows an architecture for directional audio coding (DirAC) synthesis according to an embodiment of the invention.

FIG. 4 shows audio signals from different conference rooms according to an embodiment of the invention.

FIG. 5 shows different audio images that are panned into remapped audio images according to an embodiment of the invention.

FIG. 6 shows a transformation for compressing audio images according to an embodiment of the invention.

FIG. 7 shows positioning of physical loudspeakers relative to virtual sound sources according to an embodiment of the invention.

FIG. 8 shows an example of positioning of a virtual sound source in accordance with an embodiment of the invention.

FIG. 9 shows an apparatus for re-panning an audio signal according to an embodiment of the invention.

### DETAILED DESCRIPTION OF THE INVENTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

As will be further discussed, embodiments of the invention may support the re-panning multiple audio (sound) signals by applying spatial cue coding. Sound sources in each of the signals may be re-panned before the signals are mixed to a combined signal. For example, processing may be applied in a conference bridge that receives two omni-directionally recorded (or synthesized) sound field signals as will be further discussed. The conference bridge subsequently re-pans one of the signals to the listeners left side and the signal to the right side. The source image mapping and panning may further be adaptively based on the content and use case. Mapping may be done by manipulating the directional parameters prior to directional decoding or before directional mixing.

As will be further discussed, embodiments of the invention support a signal format that is agnostic to the transducer system used in reproduction. Consequently, a processed signal may be played through headphones and different loudspeaker setups.

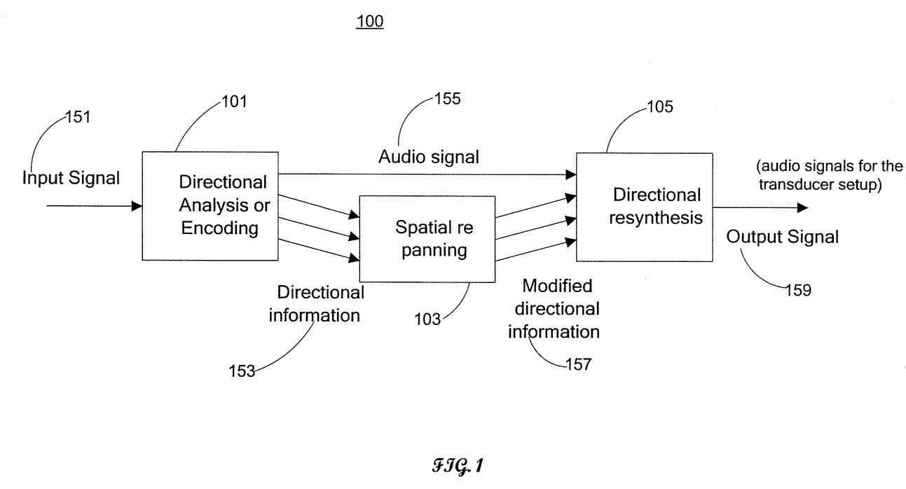

FIG. 1 shows architecture 100 for re-panning audio signal 151 according to an embodiment of the invention. (Panning is the spread of a monaural signal into a stereo or multi-channel sound field. With re-panning, a pan control typically varies the distribution of audio power over a plurality of loudspeakers, in which the total power is constant.)

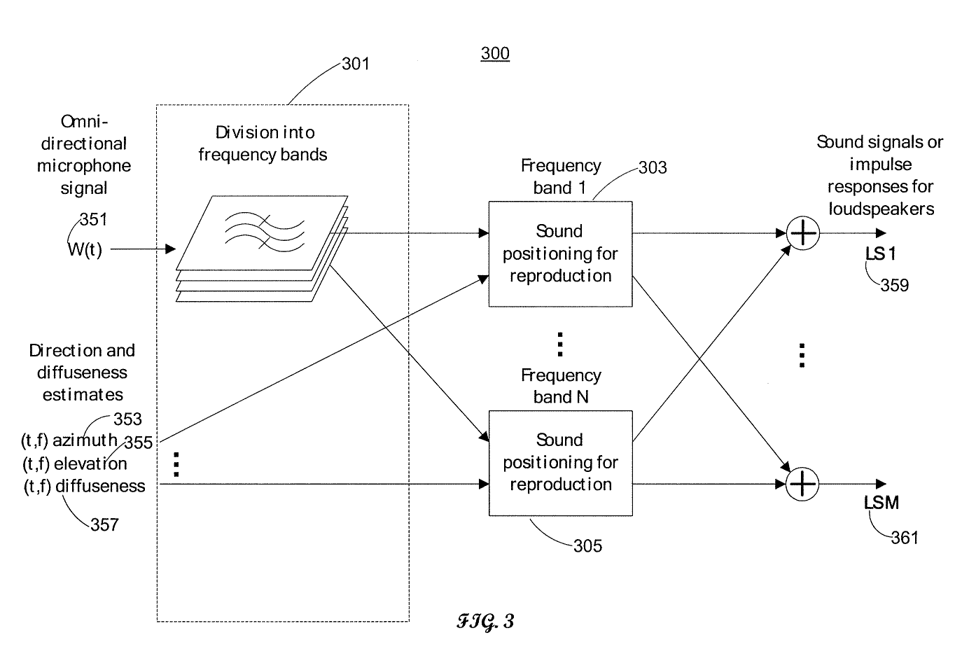

Architecture 100 may be applied to systems that have knowledge of the spatial characteristics of the original sound fields and that may re-synthesize the sound field from audio signal 151 and available spatial metadata (e.g., directional information 153). Spatial metadata may be available by an analysis method (performed by module 101) or may be included with audio signal 151. Spatial re-panning module 103 subsequently modifies directional information 153 to obtain modified directional information 157. (As shown in FIG. 3, directional information may include azimuth, elevation, and diffuseness estimates.)

Directional re-synthesis module 105 forms re-panned signal 159 from audio signal 155 and modified directional information 157. The data stream (comprising audio signal 155 and modified directional information 157) typically has a directionally coded format (e.g., B-format as will be discussed) after re-panning.

Moreover, several data streams may be combined, in which each data stream includes a different audio signal with corresponding directional information. The re-panned signals may then be combined (mixed) by directional re-synthesis module 105 to form output signal 159. If the signal mixing is performed by re-synthesis module 105, the mixed output stream may have the same or similar format as the input streams (e.g., audio signal with directional information). A system performing mixing is disclosed by U.S. patent application Ser. No. 11/478,792 (“DIRECT ENCODING INTO A DIRECTIONAL AUDIO CODING FORMAT”, Jarmo Hiipakka) filed Jun. 30, 2006, which is hereby incorporated by reference. For example, two audio signals associated with directional information are combined by analyzing the signals for combining the spatial data. The actual signals are mixed (added) together. Alternatively, mixing may happen after the re-synthesis, so that signals from several re-synthesis modules (e.g. module 105) are mixed. The output signal may be rendered to a listener by directing an acoustic signal through a set of loudspeakers or earphones. With embodiments of the invention, the output signal may be transmitted to the user and then rendered (e.g., when processing takes place in conference bridge.) Alternatively, output is stored in a storage device (not shown).

Modifications of spatial information (e.g., directional information 153) may include remapping any range (2D) or area (3D) of positions to a new range or area. The remapped range may include the whole original sound field or may be sufficiently small that it essentially covers only one sound source in the original sound field. The remapped range may also be defined using a weighting function, so that sound sources close to the boundary may be partially remapped. Re-panning may also consist of several individual re-panning operations together. Consequently, embodiments of the invention support scenarios in which positions of two sound sources in the original sound field are swapped.

If directional information 153 contains information about the diffuseness of the sound field, diffuseness is typically processed by module 103 when re-panning the sound field. Consequently, it may be possible to maintain the natural character of the diffuse field. However, it is also possible to map the original diffuseness component of the sound field to a specific position or a range of positions in the modified sound field for special effects.

To record a B-format signal, the desired sound field is represented by its spherical harmonic components in a single point. The sound field is then regenerated using any suitable number of loudspeakers or a pair of headphones. With a first-order implementation, the sound field is described using the zeroth-order component (sound pressure signal W) and three first-order components (pressure gradient signals X, Y, and Z along the three Cartesian coordinate axes). Embodiments of the invention may also determine higher-order components.

The first-order signal that consists of the four channels W, X, Y, and Z, often referred as the B-format signal. One typically obtains a B-format signal by recording the sound field using a special microphone setup that directly or through a transformation yields the desired signal.

Besides recording a signal in the B-format, it is possible to synthesize the B-format signal. For encoding a monophonic audio signal into the B-format, the following coding equations are required:

$$\begin{matrix}W ( t ) = \frac{1}{\sqrt{2}} x ( t ) \\ X ( t ) = cos θcos ϕ x ( t ) \\ Y ( t ) = sin θcos ϕ x ( t ) \\ Z ( t ) = sin ϕ x ( t )\end{matrix} , \qquad ( EQ . 1 )$$

where x(t) is the monophonic input signal, θ is the azimuth angle (anti-clockwise angle from center front), φ is the elevation angle, and W(t), X(t), Y(t), and Z(t) are the individual channels of the resulting B-format signal. Note that the multiplier on the W signal is a convention that originates from the need to get a more even level distribution between the four channels. (Some references use an approximate value of 0.707 instead.) It is also worth noting that the directional angles can, naturally, be made to change with time, even if this was not explicitly made visible in the equations. Multiple monophonic sources can also be encoded using the same equations individually for all sources and mixing (adding together) the resulting B-format signals.

If the format of the input signal is known beforehand, the B-format conversion can be replaced with simplified computation. For example, if the signal can be assumed the standard 2-channel stereo (with loudspeakers at +/−30 degrees angles), the conversion equations reduce into multiplications with constants. Currently, this assumption holds for many application scenarios.

Embodiments of the invention support parameter space re-panning for multiple sound scene signals by applying spatial cue coding. Sound sources in each of the signals are re-panned before they are mixed to a combined signal. Processing may be applied, for example, in a conference bridge that receives two omni-directionally recorded (or synthesized) sound field signals, which then re-pans one of these to the listeners left side and the other to the right side. The source image mapping and panning may further be adaptively based on content and use. Mapping may be performed by manipulating the directional parameters prior to directional decoding or before directional mixing.

Embodiments of the invention support the following capabilities in a teleconferencing system:
Re-panning solves the problem of combining sound field signals from several conference rooms
Realistic representation of conference participants
Generic solution for spatial re-panning in parameter space

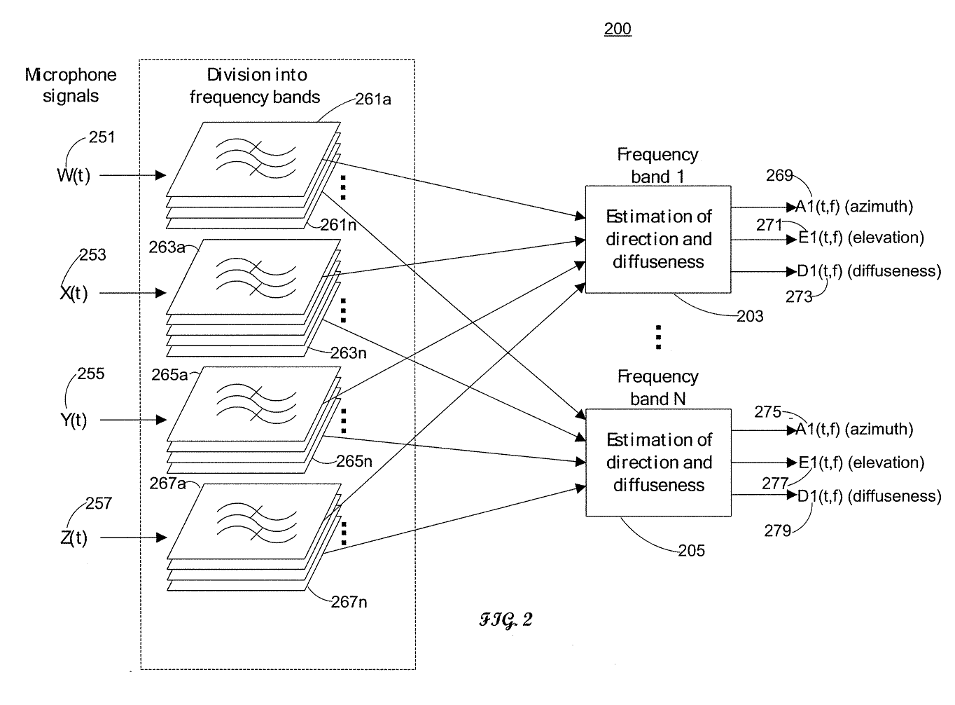

FIG. 2 shows an architecture 200 for a directional audio coding (DirAC) analysis module (e.g., module 101 as shown in FIG. 1) according to an embodiment of the invention. With embodiments of the invention, in FIG. 1, DirAC analysis module 101 extracts the audio signal 155 and directional information 153 from input signal 151. DirAC analysis provides time and frequency dependent information on the directions of sound sources regarding the listener and the relation of diffuseness to direct sound energy. This information is then used for selecting the sound sources positioned near or on a desired axis between loudspeakers and directing them into the desired channel. The signal for the loudspeakers may be generated by subtracting the direct sound portion of those sound sources from the original stereo signal, thus preserving the correct directions of arrival of the echoes.

As shown in FIG. 2, a B-format signal comprises components W(t) 251, X(t) 253, Y(t) 255, and Z(t) 257. Using a short-time Fourier transform (STFT), each component is transformed into frequency bands 261a-261n (corresponding to W(t) 251), 263a-263n (corresponding to X(t) 253), 265a-265n (corresponding to Y(t) 255), and 267a-267n (corresponding to Z(t) 257). Direction-of-arrival parameters (including azimuth and elevation) and diffuseness parameters are estimated for each frequency band 203 and 205 for each time instance. As shown in FIG. 2, parameters 269-273 correspond to the first frequency band, and parameters 275-279 correspond to the N^{th} frequency band.

FIG. 3 shows an architecture 300 for a directional audio coding (DirAC) synthesizer (e.g., directional re-synthesis module 105 as shown in FIG. 1) according to an embodiment of the invention. Base signal W(t) 351 is divided into a plurality of frequency bands by transformation process 301. Synthesis is based on processing the frequency components of base signal W(t) 351. W(t) 351 is typically recorded by the omni-directional microphone. The frequency components of W(t) 351 are distributed and processed by sound positioning and reproduction processes 305-307 according to the direction and diffuseness estimates 353-357 gathered in the analysis phase to provide processed signals to loudspeakers 359 and 361.

DirAC reproduction (re-synthesis) is based on taking the signal recorded by the omni-directional microphone, and distributing this signal according to the direction and diffuseness estimates gathered in the analysis phase.

DirAC re-synthesis may generalize a system by supporting the same representation for the sound field and use an arbitrary loudspeaker (or transducer, in general) setup in reproduction. The sound field may be coded in parameters that are independent of the actual transducer setup used for reproduction, namely direction of arrival angles (azimuth, elevation) and diffuseness.

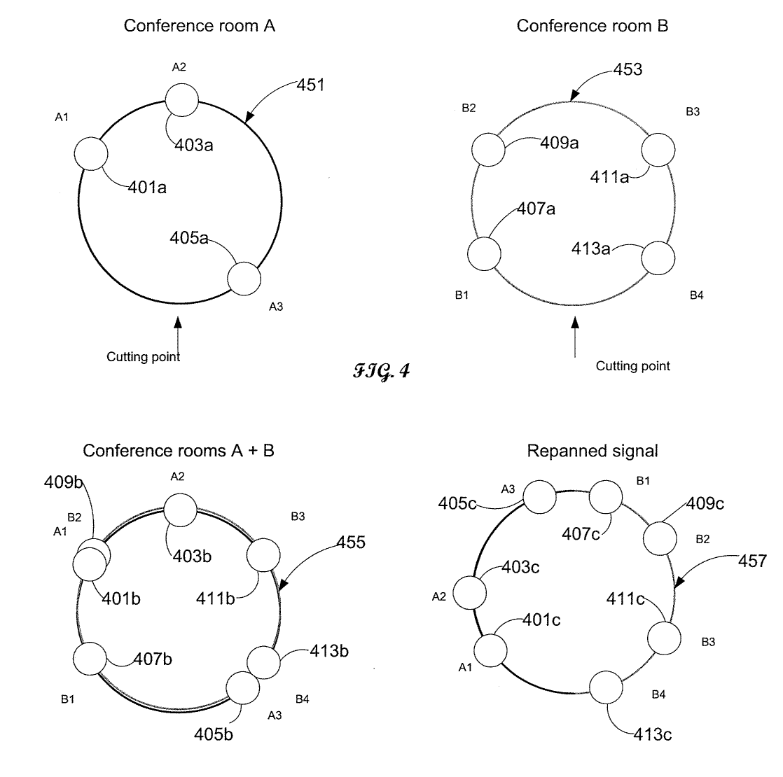

FIG. 4 shows audio signals from different conference rooms according to an embodiment of the invention. As shown in FIG. 4, sound sources 401a-405a are associated with audio signal 451 (conference site A) and sound sources 407a-413a are associated with audio signal 453 (conference site B).

With 3D teleconferencing, one major concern is to mix sound field signals originating from multiple conference spaces to better represent the teleconference. A microphone array may be used to pick-up the sound field from a conference space to produce an omnidirectional sound field signal or a binaural signal. (Alternatively, 3D representation of participants may be created using binaural synthesis) Signals 451 and 453 (from conference sites A and B, respectively) are then transmitted to the conference bridge. If the conference bridge directly combines two omnidirectional signals (corresponding to signal 455), sound source positions (401b-413b) may be mapped on top of each other (e.g., sound positions 401b and 409b). Direct mapping may be confusing for participants when some participants are essentially mapped to same position and the physical locations of the participants are not related to the position of the sound source.

Embodiments of the invention may re-pan sound field signals before they are mixed together (corresponding to re-panned signal 457 as shown in FIG. 4). Conference signal 451 from site A is spatially compressed and panned to listeners left side (corresponding to re-mapped sound sources 401c-403c). Signal 453 from site B is spatially compressed and panned to listener's right side (corresponding to re-mapped sound sources 407c-413c). Consequently, the listener can perceive participants at site A being located to the left side and at site B to the right side. This approach makes possible to group the conference participants and to position individual signals in each group close to each other in the listener's auditory space. For example, participants that are in same geographical location may be mapped close to each other, enabling the listener to identify the talkers more easily.

With embodiments of the invention, the re-panning processing (e.g., as shown in FIG. 1) may take place in a teleconferencing system at:
transmitting terminal
conference server
receiving terminal

For example, re-panning may be performed at a conference server that combines signals in a centralized system and sends combined signals to the receiving terminals. With a decentralized conference architecture, where terminals have direct connection to each other, processing may be performed at the receiving terminal. With other architectures, re-panning processing may be performed at the transmitting terminal.

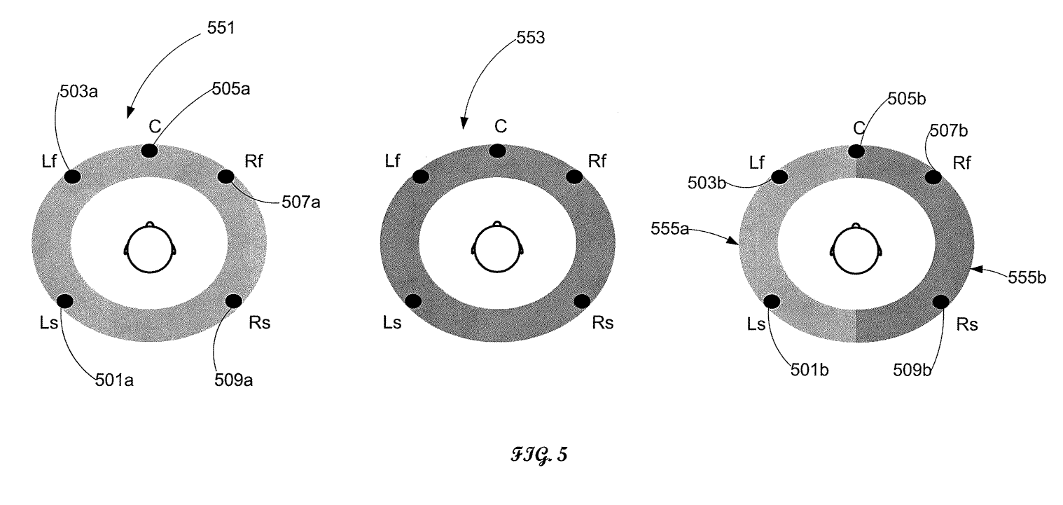

FIG. 5 shows different audio images that are panned into remapped audio images according to an embodiment of the invention. FIG. 5 illustrates the method for combining two spatial audio images created by a 5.1 loudspeaker setup. (The 5.1 speaker placement includes a front center channel speaker directly in front of the listening area, a subwoofer to the left or right of the appliance (e.g., a television), left and right main/front speakers equidistant from the front center channel speaker at approximately a 30 degree angle from the center channel, and left and right surround speakers to the left and right side just to the side or slightly behind the listening position at about 90-110 degrees from the center channel.) The original 360 degree images (corresponding to images 551 and 553 with loudspeakers 501a-509a) produced by a traditional 5.1 loudspeaker setup are compressed into left and right side 180 degree images, respectively.

Since the compressed audio images are represented with the same 5.1 loudspeaker layout, sound sources may be remapped to the new loudspeaker setup seen by the new compressed image. The original 360 degree image is constructed using five loudspeakers (center loudspeaker 505a, left front loudspeaker 503a, right front loudspeaker 507a, left surround loudspeaker 501a, and right surround loudspeaker 509a), but compressed images 555a and 555b may be created with four loudspeakers. The left side image 555a uses center loudspeaker 505b, left front loudspeaker 503b, left surround loudspeaker 501b, and right surround loudspeaker 509b. The right side image 555b uses center loudspeaker 505b, right front loudspeaker 507b, right surround loudspeaker 509b, and left surround loudspeaker 501b. It should be noted that with this configuration, surround loudspeakers 501b and 509b contribute in representing both 180 degree compressed audio images.

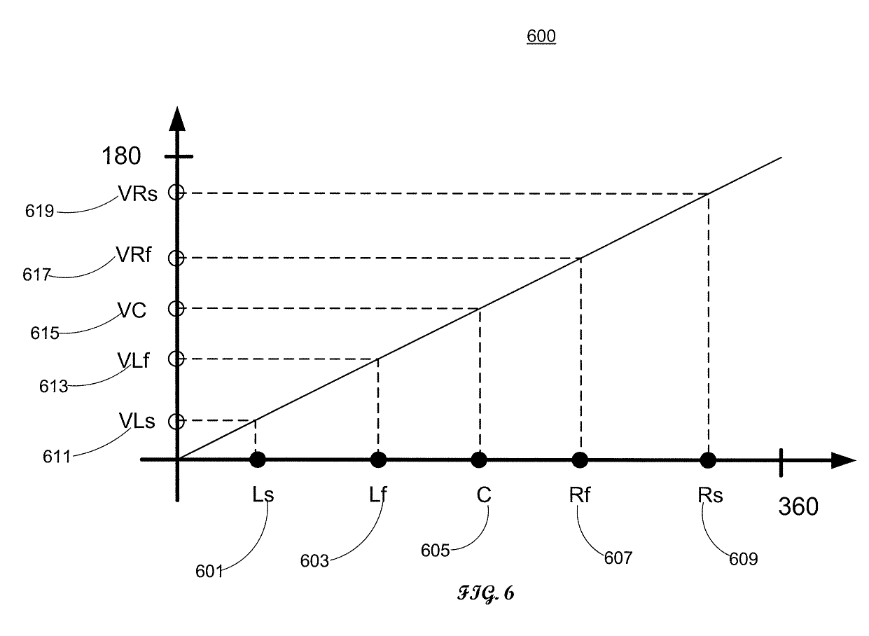

FIG. 6 shows transformation 600 for compressing audio images according to an embodiment of the invention. FIG. 6 illustrates an exemplary linear mapping of the 360 degree audio image that compresses to 180 degrees. Sound sources 601-609 (in 5.1 loudspeaker setup) are mapped into virtual sound source positions 611-619, respectively. While the exemplary mapping is linear as shown in FIG. 6, a progressive mapping or asymmetric mapping may be alternatively used.

With the example shown in FIG. 6, the original audio images are cut between the surround loudspeakers. However, the cut off point may be placed anywhere in the image. The selection may be done, for example, based on the audio content or the nature of the current audio image. The cut off position and the compression to combine audio images may also be adaptive during the audio content transmission, creation, and representation based on the content, audio image, or user selection.

If the spatial audio content primarily resides behind the listener (i.e., with surround loudspeakers), it may not be feasible to split the image by selecting the cut off point at 180 degrees. Instead, the content manager or adaptive image control may select a relatively silent area in the spatial audio image and perform the split in that area.

The image mapping from 360 to 180 degrees may further be adapted based on the audio image. The silent areas in the image may be compressed more than the active areas. For example, when there are one or more speakers in the 360 degree image, the silent area between the speakers may be compressed by adjusting the mapping curve in FIG. 6. The areas containing speech and audio may be determined, for example, using the panning law equations when the channel gains are known. Panning law provides the signal level modifications for each sound source as a function of the desired direction of arrival. Amplitude panning is typically applied to two loudspeakers which are in a standard stereophonic listening configuration, A signal is applied to each loudspeaker with different amplitudes, which can be formulated as xᵢ(t)=gᵢx(t), i=1,2, where xᵢ(t) is the signal to be applied to loudspeaker i, and gᵢ is the gain factor for each loudspeaker derived from the panning law.

The combination of several audio images in FIG. 5 does not need to be symmetric and linear. Based on the content and image characteristics, the share of the combined audio image between the component images may be variable. For example, an image containing only one loudspeaker may be compressed into less than 180 degrees, while the other scene takes a greater share of the combined image.

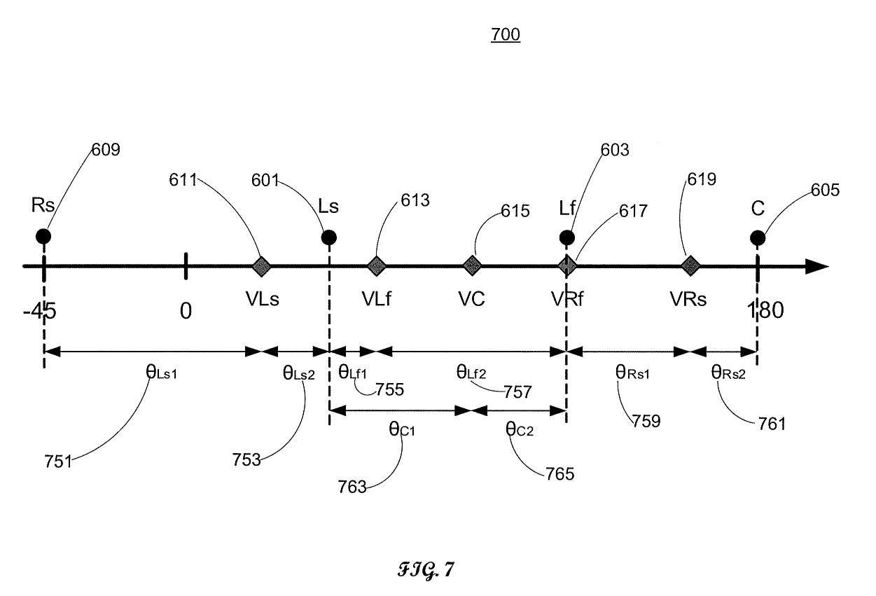

FIG. 7 shows an exemplary positioning 700 of physical (actual) loudspeakers 601-609 relative to virtual sound sources 611-619 according to an embodiment of the invention. Virtual sound sources 611-619 are mapped to the actual 5.1 loudspeaker setup as shown in FIG. 6. Separation angles 751-761 specify the relationship between physical loudspeakers 601-609 and virtual sound sources 611-619.

Virtual sound sources 611-619 may be placed in the audio image using binaural cue panning using separation angles 751-761 as shown in FIG. 7. Binaural cues are derived from temporal or spectral differences of ear canal signals. Temporal differences are called the interaural time differences (ITD), and spectral differences are called the interaural level differences (ILD). These differences are typically caused, respectively, by the wave propagation time difference (primarily below 1.5 kHz) and the shadowing effect by the head (primarily above 1.5 kHz). When a sound source is shifted, ITD and ILD cues are changed. This phenomenon may be used to create virtual sound sources 611-619 and move them between loudspeakers 601-609.

Amplitude panning is the most common panning technique. The listener perceives a virtual source the direction of which is dependent on the gain factors, i.e., amplitude level differences (ILD) of a sound signal in adjacent loudspeakers. Another method is time panning. When a constant delay is applied to one loudspeaker in stereophonic listening, the virtual source is perceived to migrate towards the loudspeaker that radiates the earlier sound signal. Maximal effect is achieved when the delay (ITD) is approximately 1.0 ms. Time panning is typically not used to position sources to desired directions; rather, it is used when some special effects are created.

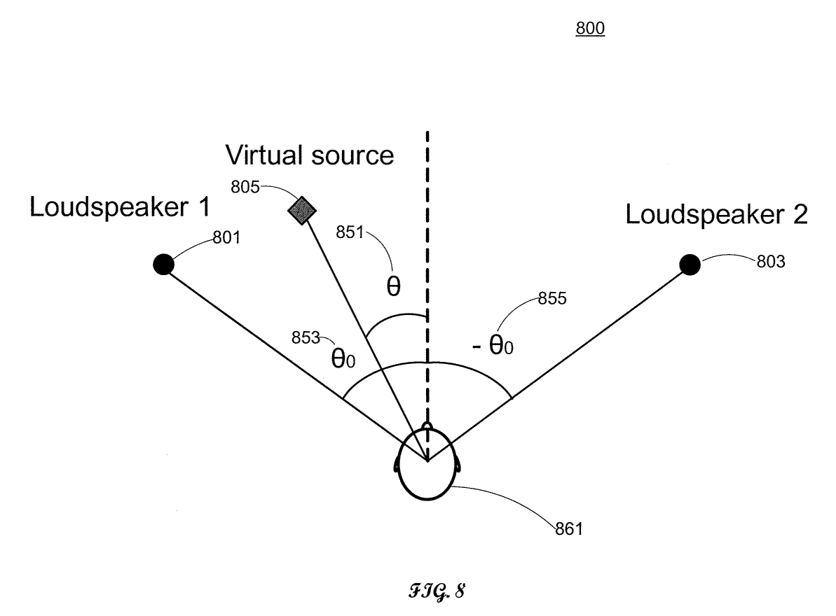

FIG. 8 shows an example of positioning of virtual sound source 805 (e.g., virtual sources 611-619) in accordance with an embodiment of the invention. Virtual source 805 is located between loudspeakers 801 and 803 as specified by separation angles 851-855. The separation angles, which are measured relative to listener 861, are used to determine amplitude panning. When the sine panning law is used, the amplitudes for loudspeakers 801 and 803 are determined according to the equation

$$\frac{sin θ}{sin {θ}_{0}} = \frac{{g}_{1} - {g}_{2}}{{g}_{1} + {g}_{2}} \qquad ( EQ . 2 )$$

where g₁ and g₂ are the ILD values for loudspeakers 801 and 803, respectively. The amplitude panning for virtual center channel (VC) using loudspeakers Ls and Lf in FIG. 6 is thus determined as follows

$$\frac{sin ( ( {θ}_{C 1} + {θ}_{C 2} ) / 2 - {θ}_{C 1} )}{sin ( ( {θ}_{C 1} + {θ}_{C 2} ) / 2 )} = \frac{{g}_{Ls} - {g}_{Lf}}{{g}_{Ls} + {g}_{Lf}} \qquad ( EQ . 3 )$$

Similar amplitude panning is needed for each virtual source in FIG. 6 to create the full spatial image. Virtual sources are panned using the actual loudspeakers as follows
VLs using surround loudspeakers Rs and Ls
VLf using Ls and Lf
VC using Ls and Lf
VRf mapped to Lf
VRs using Lf and C

In total, nine ILD values are needed to map five virtual channels in the given configuration. Similar mapping is done for right hand side as well. One may not be able to solve EQ. 3 for all sound sources. However, since the overall loudness is maintained constant according to EQ. 4, the gain values for individual loudspeakers can be determined.

$$\sqrt{{\sum }_{n = 1}^{N} {g}_{n}^{2}} = 1 \qquad ( EQ . 4 )$$

It should be noted that by using the presented combination of audio images, the surround loudspeakers (Ls) 601 and (Rs) 609 as well as center loudspeaker (C) 605 contribute to representation of both (left and right) virtual images. Therefore, when determining the gain values for the combined image, one should verify that the surround and center loudspeaker powers do not saturate.

The determined ILD values from EQs. 3 and 4 are applied to loudspeakers by multiplying the virtual source level with respective ILD value. Signals from all virtual sources are added together for each loudspeaker. For example, the left front loudspeaker signal is determined using four virtual sources as follows:

s_{Lf}(i)=g_{Lf(VLf)}s_{VLf}(i)+g_{Lf(VC)}s_{VC}(i)+g_{Lf(VRf)}s_{VLRf}(i)+g_{L6f(VRs)}s_{VRs}(i) (EQ. 5)

If the audio image mapping and image compression are constant, one may need to determine the ILD values in EQs. 3 and 4 only once. However, when the image is adapted, either by changing the compression, cut of position, or the combination of the images, new ILD mapping values need to be determined again.

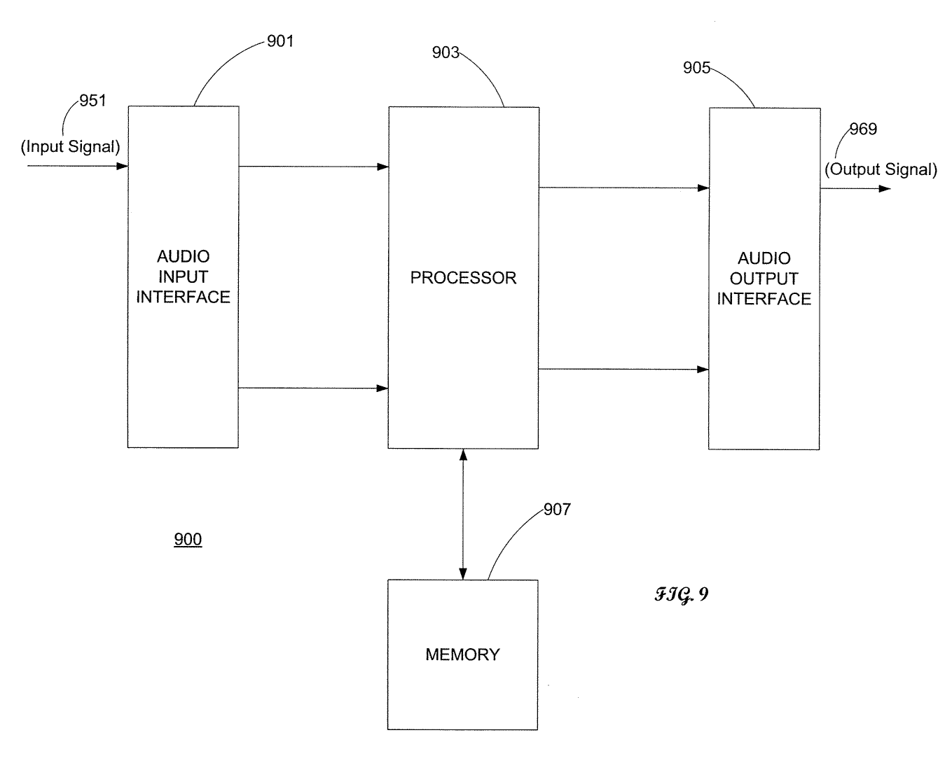

FIG. 9 shows an apparatus 900 for re-panning an audio signal 951 to re-panned output signal 969 according to an embodiment of the invention. (While not shown in FIG. 9, embodiments of the invention may support 1 to N input signals.) Processor 903 obtains input signal 951 through audio input interface 901. With embodiments of the invention, signal 951 may be recorded in a B-format, or audio input interface may convert signals 951 in a B-format using EQ. 1. Modules 101, 103, and 105 (as shown in FIG. 1) may be implemented by processor 903 executing computer-executable instructions that are stored on memory 907. Processor 903 provides combined re-panned signal 969 through audio output interface 905 in order to render the output signal to the user.

Apparatus 900 may assume different forms, including discrete logic circuitry, a microprocessor system, or an integrated circuit such as an application specific integrated circuit (ASIC).

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method comprising:
obtaining a first input signal and a second input signal;
re-panning the first input signal and the second input signal to form a first re-panned signal and a second re-panned signal, respectively;
mixing the first and the second re-panned signals to form an output signal; and
rendering the output signal for a user.

2. The method of claim 1, further comprising:
converting the output signal into an acoustic signal.

3. The method of claim 2, further comprising:
directing the acoustic signal through an acoustic output unit.

4. The method of claim 3, the acoustic output unit comprising at least one loudspeaker.

5. The method of claim 1, further comprising:
storing the output signal on a storage device.

6. The method of claim 1, the first input signal being associated with first directional information, the method further comprising:
remapping the first directional information.

7. The method of claim 6, further comprising:
compressing input source positions into virtual source positions.

8. The method of claim 7, further comprising:
linearly compressing the virtual source positions.

9. The method of claim 6, the second input signal being associated with second directional information, the method further comprising:
remapping the second directional information.

10. The method of claim 1, further comprising:
placing a virtual source using binaural cue panning.

11. The method of claim 11, further comprising:
determining amplitude levels for a plurality of loudspeakers.

12. The method of claim 1, the plurality of loudspeakers comprising a first loudspeaker and a second loudspeaker, the method further comprising:
determining a first amplitude level difference (g1) for the first loudspeaker and a second amplitude level difference (g2) for the second loudspeaker.

13. The method of claim 1, further comprising:
grouping participants according to a geographical location.

14. The method of claim 1, further comprising:
determining first directional information from the first input signal and second directional information from the second input signal; and
forming the first re-panned signal based on the first directional information and the second re-panned signal based on the second directional information.

15. The method of claim 1, the first directional information comprising an azimuth value.

16. The method of claim 15, the first directional information further comprising a diffuseness value.

17. The method of claim 1, further comprising:
obtaining another input signal;
re-panning the other input signal to form another re-panned signal; and
mixing the other re-panned signal with the first and the second re-panned signals to form the output signal.

18. An apparatus comprising:
an input module configured to obtain a first input signal, a second input signal, first directional information, and second directional information, the first directional information being associated with the first input signal and the second directional information being associated with the second input signal;
a re-panning module configured to modify the first directional information and the second directional information; and
a synthesizer configured to form a first re-panned signal based on the modified first directional information and the modified second directional information and to mix the first re-panned signal and the second re-panned signal to obtain an output signal.

19. The apparatus of claim 18, further comprising:
an analysis module configured to determine the first directional information from the first input signal and the second directional information from the second input signal.

20. The apparatus of claim 18, the re-panning module further configured to compress input source positions into virtual source positions.

21. The apparatus of claim 18, the synthesizer further configured to place a virtual source using binaural cue panning.

22. The apparatus of claim 21, the synthesizer further configured to determine amplitude levels for a plurality of loudspeakers.

23. A computer-readable medium having computer-executable instructions comprising:
obtaining a first input signal and a second input signal;
re-panning the first input signal to form a first re-panned signal and the second input signal to form a second re-panned signal;
mixing the first re-panned signal and the second re-panned signal to form an output signal; and
rendering the output signal for a user.

24. The computer-readable medium of claim 23, further comprising:
associating the first input signal being associated with first directional information; and
remapping the first directional information.

25. The computer-readable medium of claim 24, further comprising:
compressing input source positions into virtual source positions.

26. The computer-readable medium of claim 23, further comprising:
placing a virtual source using binaural cue panning.

27. An apparatus comprising:
means for obtaining a first input signal and a second input signal;
means for re-panning the first input signal to form a first re-panned signal and the second input signal to form a second re-panned signal;
means for mixing the first re-panned signal and the second re-panned signal to form an output signal; and
means for rendering the output signal for a user.

28. The apparatus of claim 27, further comprising:
means for associating the first input signal being associated with first directional information; and
means for remapping the first directional information.

29. The apparatus of claim 27, further comprising:
means for placing a virtual source using binaural cue panning.

30. An integrated circuit comprising:
an input component configured to obtain a first input signal, a second input signal, first directional information, and second directional information, the first directional information being associated with the first input signal and the second directional information being associated with the second input signal;
a re-panning component configured to modify the first directional information and the second directional information; and
a synthesizing component configured to form a first re-panned signal based on the modified first directional information and the modified second directional information and to mix the first re-panned signal and the second re-panned signal to obtain an output signal.

31. The integrated circuit apparatus of claim 30, further comprising:
an analysis component configured to determine the first directional information from the first input signal and the second directional information from the second input signal.
